(19) United States
(12) Patent Application Publication
(10) Pub. No.: US 2006/0172177 A1
(43) Pub. Date: Aug. 3, 2006

(54) Electromagnetic system with a supply plate

(76) Inventors: Joachim Scherer, Ulm (DE); Bernd Ruess, Vohringen (DE); Dieter Grafl, Ulm (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/286,577

(22) Filed: Nov. 23, 2005

(30) Foreign Application Priority Data
Nov. 24, 2004 (DE) 10 2004 057 447.2

(51) Int. Cl. H01M 8/24; H01M 8/02

(52) U.S. Cl. 429/38

(57) ABSTRACT

The present invention relates to an electrochemical system (1) as well as to a supply plate (2) which is contained in this system. At least one supply plate is provided in this electrochemical system, wherein the supply plate on a first flat side comprises a first flowfield, and on a second flat side a second flowfield and the first flowfield is connected to an allocated first interface channel and the second flowfield to an allocated second interface channel, in a fluid-leading manner, or an individual interface channel is connected to the first and to the second flowfield in a fluid leading manner, wherein a transition region is arranged from at least one interface channel to the allocated flowfield or to the allocated flowfields, wherein this transition region on the first flat side comprises a first section and on the second flat side comprises a second section, for pressing a membrane bordering on the respective flat side, wherein the first and the second section are offset in the plane of the plate so that a reaction media flowing in each case on the sides which are distant to the pressing sides of the first and second channel may get from the interface channel to the flowfield or the flowfields.

The present invention relates to an electrochemical system as well as a supply plate contained therein.

Electrochemical systems such as polymer electrolyte membrane fuel cells (PEMFC), direct methanol fuel cells (DMFC), high-temperature fuel cells, electrochemical hydrogen compressors or electrolysers are known in principle. Usually, these electrochemical systems comprise a plurality of cells which are separated from one another by way of supply plates. These supply plates have the task of leading reaction media such as for example molecular hydrogen or oxygen, or air, to the reaction surfaces of the corresponding membranes. For increasing the power density, usually (but not necessarily), a plurality of supply plates are provided, between which in each case suitable membranes are arranged.

The supply plates are usually designed in a flat manner and comprise a first flat side as well as a second flat side. A first flowfield is arranged on the first flat side, and a second flowfield on the second flat side, for the media supply to a respective bordering membrane with a reaction medium. With this, interface channels serve for the supply into the flowfields, and are for example arranged perpendicular to a layering of the supply plates, and in this manner several supply plates may be simultaneously supplied with reaction media, or lead away the reaction media or reaction products from several flowfields.

The disadvantage with the systems up to now is the fact that here, for sealing the individual reaction media from one another, in particular in the region of the transition of the interface channels to the flowfields, one must apply additional seals in order to ensure a correct operation of the system. Usually for example with fuel cell stacks, two separate sealing frames are applied per cell, in order to seal the cells and to support the membrane in the entry/exit region. The separate sealing frames hereby multiply the number of stack components, in each case produce an additional sealing surface, and furthermore necessitate a high precision on their manufacture (since only narrow thickness tolerance must be achieved). On the other hand, according to the state of the art, it is also impossible to avoid such sealing frames, since the reaction membrane needs to be supported in a suitable manner in the region of the transition of the interface channels to the flowfield. On account of the lacking support, here the membrane in the region of the interface channel may fall into the channel towards the flowfield, by which means a passing of the one reaction medium to the side of the second reaction medium could occur. Furthermore, due to the membrane falling into the channel running between the interface channel and the flowfield, this channel may become blocked, by which means the cell concerned would no longer be adequately supplied with reaction medium.

Proceeding from this state of the art, it is therefore the object of the present invention to provide a system which on the one hand may be manufactured in a simple and inexpensive manner, and on the other hand displays no sealing problems, in particular in the transition region between the interface channel and the flowfield.

This object is achieved by the subject-matter of the independent patent claims:

According to the invention, an electrochemical system with at least one supply plate is provided, wherein
the supply plate on a first flat side comprises a first flowfield, and on a second flat side comprises a second flowfield and
the first flowfield is connected to an allocated first interface channel in a fluid-leading manner, and the second flowfield is connected to an allocated second interface channel in a fluid-leading manner, or an individual interface channel is connected to the first and to the second flowfield in a fluid-leading manner, wherein according to the invention
a transition region is arranged from at least one interface channel to the allocated flowfield (with bipolar plates), or to the allocated flowfields (with monopolar plates), wherein this transition region on the first flat side comprises a first section and on the second flat side comprises a second section, for pressing a membrane bordering the respective flat side.

Three variants of the invention are particularly worth mentioning:

a) additionally to the above-mentioned features, it is particularly advantageous if the first and the second section of the plane of the plate are offset from each other, so that a reaction medium in each case flowing on the side which is distant to the pressing sides of the first and second section may get from the interface channel or interface channels to the flowfield or the flowfields respectively. A so-called “alternating tunnel” is created by way of this. By way of this, it becomes possible, without expensive bead arrangements or likewise, to achieve a secure connection from the interface channel to the flowfield. With regard to this, it is particularly advantageous that this is also possible with a plate with a uniform upper contour, i.e. no specially projecting topography (such as beads) is required. The offset of the first and of the second section according to the invention here only needs to be designed such that a throughput of medium between two sections is still possible. For this, these may be adjacent, but they may also partly overlap in the plane of the plate. In this case, preferably lower thicknesses or further openings are to be provided, so that here a desired flow through the transition region is made possible.

b) a further, particularly advantageous main variant envisages a transition region being arranged from the interface channel to the allocated flowfields, wherein an allocation of the reaction medium from the interface channel to both flat sides and the allocated flowfields is effected there. This construction manner is particularly suitable for “monopolar current collector plates”.

c) a further main variant of the invention furthermore envisages the supply plate being of one layer in the electrochemical system according to the invention. It is not necessary to join supply plates of several layers together or to arrange them over one another. One may also largely avoid the need of sealing frames etc. This is particularly favourable for the manufacturability, since in this manner, one may manufacture single-layer and single-part components. Here “single-layer” is to be understood as only one layer of the same material being necessary (for example a injection moulded plastic part). A coating of this (for example with a conductive surface) should however be possible despite this. However, what is ruled out is the supply plate for example being constructed of two sheet [metal] plates which for example form an inner cavity, etc.

The invention in practise may be applied to all types of supply plates. Thus the invention may for example be applied to monopolar current collector plates. Here, as a rule, an interface channel supplies two flowfields of which one is attached on the first (for example upper) flat side, and one on the second (thus lower) flat side of the plate. The flowfields on the upper and lower side (thus the first and the second side respectively) are thus connected to one another.

However the application to bipolar plates is also possible. Here e.g. an interface channel running perpendicular to the stack direction in each case supplies only one side of the respectively connected plate, for example always the “upper side” (or “first flat side”). The respective second flat side or “lower side” is connected to another interface channel. A fluid-leading connection is not given between the first flat side and the second flat side of a plate, or between a first flowfield (specifically that on the first plate) and a second flowfield (specifically that on the second plate).

One may avoid with additional sealing frames by way of the particular design of the transition region according to the invention. This is due to the fact that this transition region comprises a “tunnel structure” which on a first flat side comprises a first section for pressing a membrane, and on the second flat side comprises a second section for pressing a further membrane, and thus the respective membranes are supported by these sections in each case in the desired manner, so that no additional inlays or sealing frames are required in order to support the membrane.

Thus in particular, it is possible to hold the membrane in its edge regions such that (e.g. with a PEMFC), no reaction medium may get to the distal side of the membrane, and thus for example cause a mixing of the reaction media, and thus a malfunctioning of the cell.

Thus one may therefore avoid with separately applied sealing frames on account of the new way of leading the media in the entry/exit region of the flowfield channels. On account of the integration of the sealing frame functionalities (sealing, path limitation on compression of the MEA (electrode membrane assembly), support of the membrane), it is possible to make the construction of the stack significantly simpler and more reliable by way of the achieved modular construction manner. Due to the omission of the separate sealing frames, the number of the components which are to be aligned on assembly is significantly reduced and thus the process reliability of the stack assembly is significantly increased. Furthermore, the manufacture of the stack components is simplified, since the production of the sealing frames which are to some extent very filigree, entails great difficulties (high scrab rate, problems with precision). The design is particularly suitable for fuel cell systems which make do without a cooling layer which otherwise is usually used in order to tunnel through the leading of the media below the sealing lines. Thus the system is in particular also suitable for DMFC or cathode-air-cooled stacks or systems which have a monopolar stack construction.

A decisive aspect of the “frameless design” is a necessary adaptation of the respective membrane to the structure for leading the media. The membrane must therefore end at the edge of the respective surface which it still just supports. One may thus effectively prevent the falling of “unsupported” membrane regions into the transition region or the interface channel.

Advantageous designs of the present invention are specified in the dependent claims.

A further formation of the supply plate envisages this for example being a monopolar current collector plate or also a bipolar plate.

With the use of a system with monopolar current collector plates, it is advantageous that here one may supply two cells with a single flowfield channel, since here a continuous aligned channel is given. Due to this possibility of supplying two cells simultaneously, one may furthermore achieve a significant reduction of the thickness of the plate or of the total arrangement.

Depending on which plate concept is applied here, one may also select the materials in a different manner. Thus for supporting the sealing effect as well as for the electrical insulation between two oppositely lying individual cells, for example with the use of plate of conductive plastics (e.g. graphite composites), the monopolar or bipolar plate may be specially coated with an insulating material, e.g. a rubber, in the transition region.

A further advantageous embodiment envisages reactive membranes being attached on both sides of the supply plate. These may, (as is usual with a PEMFC) for example be polymer electrolyte membranes (ion exchanger membranes) coated with a catalyst on both sides. In other embodiments of the invention, the membranes however may also be simple separators for example. It is to be noted that it is not absolutely necessary for chemically reactive membranes to be deposited on both sides, and it may also be the case of films sealing at least on one side, etc.

A further advantageous embodiment envisages the membranes on one or two of the flat sides of the supply plate being flush with the outer contour of the supply plate or being set back with respect to this. Thus the assembly of the cells is relatively simple with the flush variant, since one may always externally examine as to whether the membrane for example has been unintentionally bent in a broken manner or not. In the case in which the membrane is set back inwardly with respect to the edges of the supply plates, it is advantageous that here one requires less of the membrane which under certain circumstances may be quite expensive. With this set-back variant however, a projection of the plate in the edge region is to be preferably provided in order to compensate the volume which has arisen on pressing the stack due to the omission of the membrane, and to continue to lead the force engagement of the pressing in a homogenous manner.

A further advantageous formation envisages at least one membrane which is flush with respect to the outer contour of the supply plate, at least in regions, having a cut-out around the region of the interface channels. Thereby, it is also an advantage that the above-mentioned cut-out of the membrane, apart from the contour of the respective interface channel, also includes the contour of the first or the second section of the transition region. With this, the cut-out of the membrane however is extended up to the edge of that section which, proceeding from the interface channel, comes into contact with the membrane last of all. By way of this, it is ensured that the membrane is in contact with the bordering supply plates in the complete transition region of both sides. Due to this, it is ensured that the membrane does not fall into the transition region or into the interface channel and blocks this. Furthermore one prevents the reaction medium led in the interface channel from passing over to the membrane side of the respective other medium.

A further, advantageous feature results on account of special contour of the membrane cut-out in the transition region between an interface channel and the flowfield connected thereto, said contour resulting according to the principle described above. By way of a suitable arrangement of the respective interface channels and the corresponding transition regions to one another, according to the principle described above, a specific “hole pattern” of the membrane results, which on assembly of the fuel cell stack permits the positional correctness of the membrane to be determined and to be controlled. By way of this, it is possible to ensure that for example the electrodes of the MEA which are designed for the anode reaction of the fuel cell may be exclusively installed in such that it faces the anode flowfield of the supply plate. A inversion of the anode or the cathode of the MEA, by which means the power of the cell may be significantly decreased, is avoided with this.

A further advantageous formation envisages the provision of two or more interface channels per allocated flowfield. Thus for example an interface channel may be used for supplying reaction medium (for example molecular hydrogen), and one may be used for leading away for example excess hydrogen which thus has not been consumed, as well as reaction products.

A further advantageous formation envisages the first and/or the second section having maximally 30% to 70%, preferably 40% to 60% of the height of the supply plate in the direction of the layering of the system. Thus an adequate cross-section for the flow of reaction medium from the interface channel into the flowfield is always possible in the remaining residual region. With this, it is advantageous for the first and the second section of the transition region to be offset in the plane of the plate, so that an “alternating tunnel” may arise by way of this.

It is further advantageous if the first section of the transition region towards the first flowfield is designed flush at the edge with an inner contour of the flowfield. Thus the flowfield in a plan view of the plate may be designed in a simple rectangular manner. No reduction in the active surface in the region of the transition region to the interface channels is required.

A further advantageous formation envisages a preferably interrupted support structure being provided in the region between the first and the second section. This is particularly meaningful with wider transitions between the first and the second section of the transition region, since the mechanical stability of the supporting section of the transition region perpendicular to the flat side of the supply plate is increased by way of this. Thereby, one advantageous embodiment envisages the support structure on the first and/or second flat side being raised beyond this flat side, distally to the oppositely lying flat side, over the remaining plane of the plate. This serves for compensating the missing membrane in this region, said membrane being cut out in a manner adapted to the contour of the transition region. The projection should be selected according to the thickness of the membrane. This projection is to be designed in an electrically insulating manner, such as by way of a coating or the selection of a plate material. This variant furthermore has the further advantage that a inversion of the sides is more likely to be avoided by way of the specific cut-out of the membranes.

The supply plate in the electrochemical system according to the invention may be designed in various manners. This therefore at least in regions, may be a injection moulded plastic part, and also a graphite composite plate is alternatively possible. Preferably electrically insulation regions (for example of rubber or coated with a non-conducting polymer) are to be provided in the case of such a conductive plate. The supply plate may additionally be provided with linear or surfaced seals.

Further advantageous embodiment are described in the remaining claims.

The invention is hereinafter described by way of several figures. There are shown in:

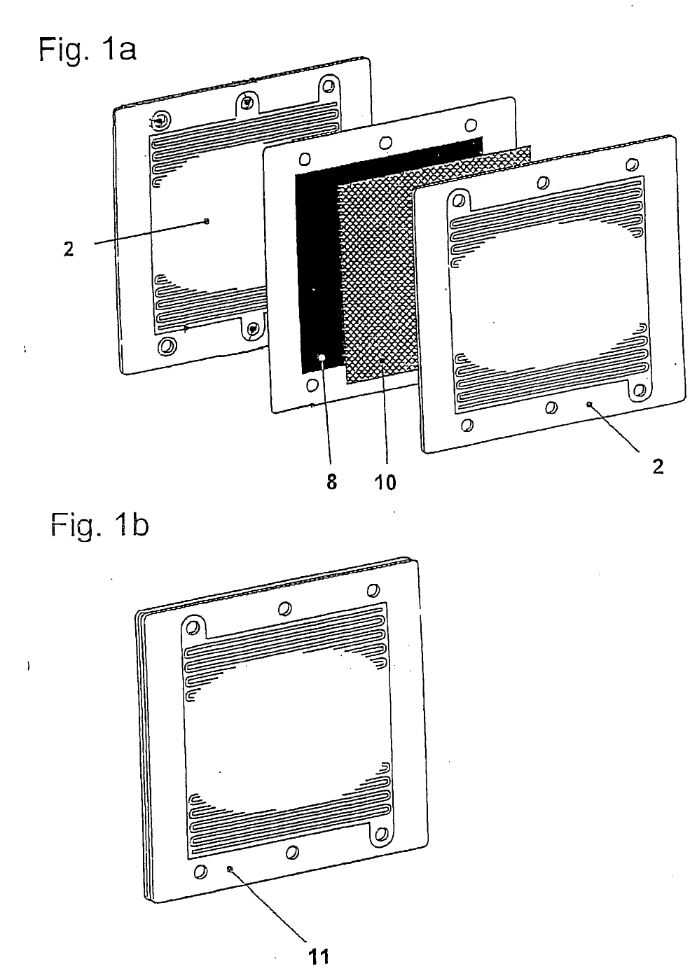

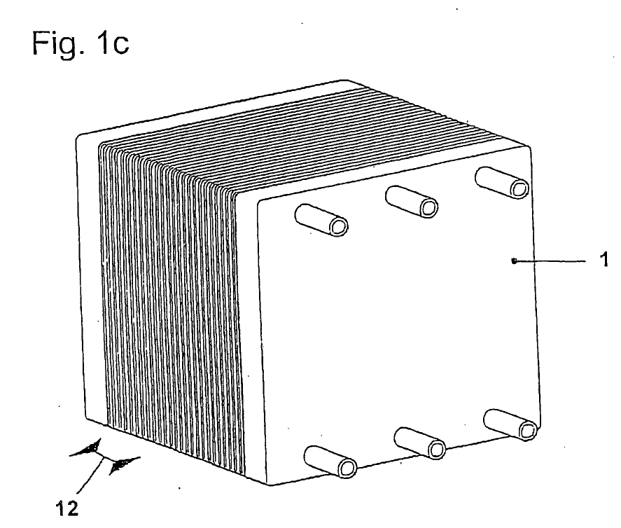

FIGS. 1a to 1c the basic construction of an electrochemical system;

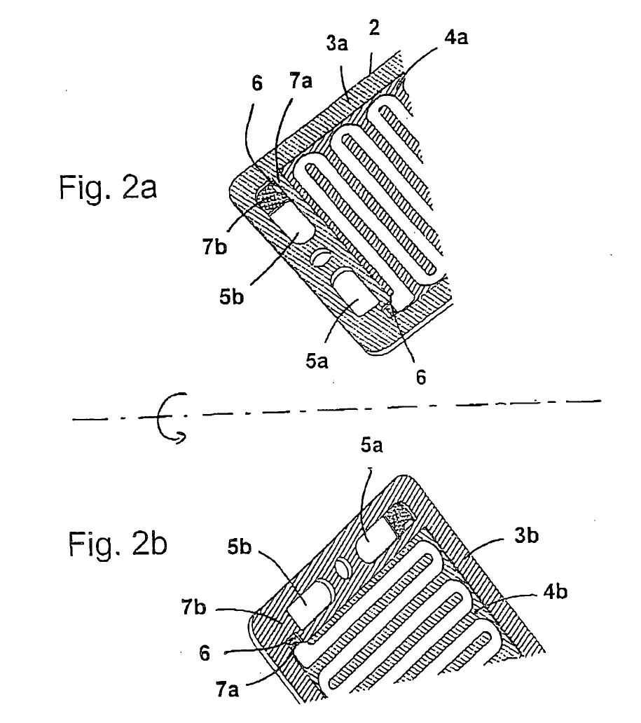

FIGS. 2a and 2b a first embodiment of a supply plate according to the invention as well as

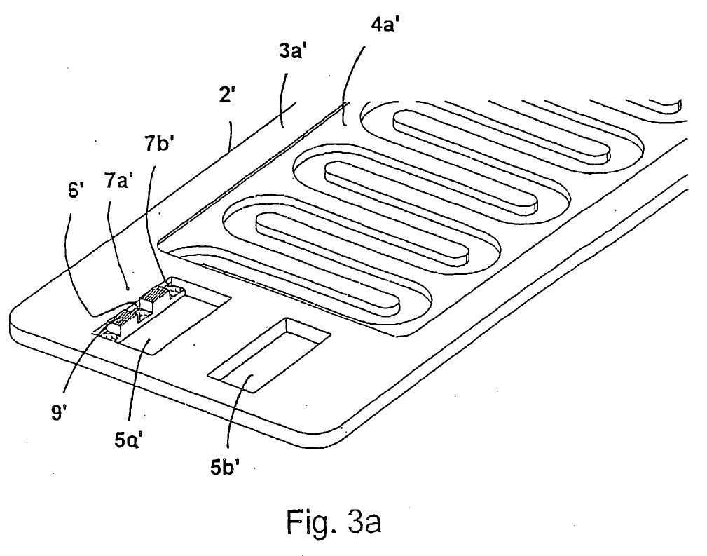

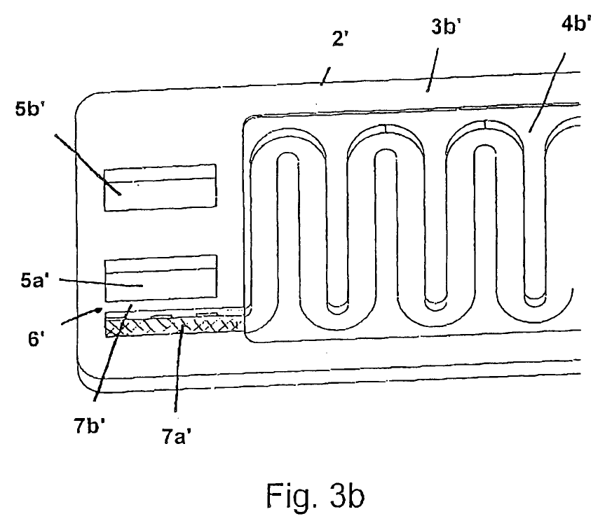

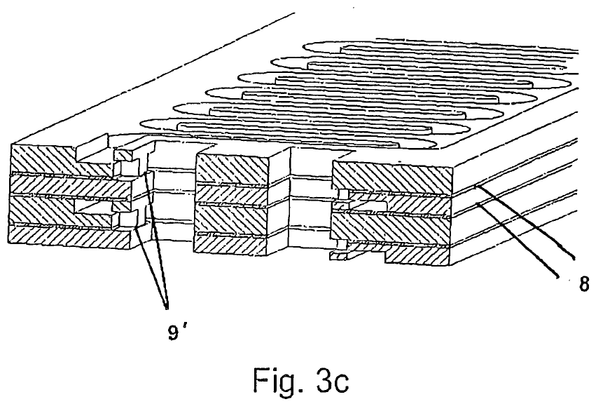

FIGS. 3a to 3ca further embodiment of a supply plate according to the invention.

FIGS. 1a to 1c show a basic construction of an electrochemical system. Here, a fuel cell system is represented by way of example, which comprises supply plates 2 in the form of bipolar plates. Hereby, in each case two supply plates 2 are provided on both sides of a membrane 8. Hereby, a gas diffusion layer 10 may be optionally provided between the membrane and the respective supply plate.

Here FIG. 1b schematically represents an individual cell which comprises two bipolar plates with the above-mentioned elements lying therebetween. Then in the condition shown in FIG. 1c, further membranes 8 connect to both sides of this individual cell. Thus a layering of cells (a stack) arises, as is shown in FIG. 1c. Hereby, the “direction of the layering” is indicated in FIG. 1c at 12, in which mechanical pressure is exerted transverse to the flat sides of the supply plates.

In particular, various types of the supply plates as well as the interface channels which run in the direction of the layering 12 and which are to supply flowfields on both sides of the supply plates 2, are to be dealt with in the following.

A first embodiment of a supply plate according to the invention is shown in FIGS. 2a and 2b. Here it is the case of a “bipolar plate”.

FIGS. 2a and 2b in each case show different sides of the same bipolar plate. Here, the dot-dashed line introduced between the figures indicates that the plate shown in FIG. 2a may be brought into the condition 2b with which one then sees the “rear side” of this plate, by way of a corresponding rotation about this dot-dashed line.

From the FIGS. 2a as well as 2b, one may easily recognise the construction of the supply plate which is basically shown in FIG. 1a.

The supply plate 2 on a first flat side 3a comprises a first flowfield 4a (see FIG. 2a). On a second flat side (i.e. the oppositely lying flat side of the supply plate 2), this comprises a second flat side 3b as well as a second flowfield 4b (see FIG. 2b). The flowfields on both sides represent the electrochemically active region and (as for example indicated in the FIGS. 1a and 1b) are essentially rectangular (centred rectangle within the plate 2). The first flowfield 4a is connected to an allocated first interface channel 5a (see FIG. 2a). The second flowfield 4b is connected to an allocated second interface channel 5b in a fluid-leading manner (see FIG. 2b).

A transition region 6 is arranged from the interface channel 5a to the allocated flowfield 4a, wherein this transition region on the first flat side 3a comprises a first section 7a, and on the second flat side 3b a second section 7b, for pressing a membrane 8 bordering the respective flat side (see FIG. 1a).

The transition region 6 is to be dealt with once again in detail hereinafter. This comprises an integrated web (section 7a) which forms a part of the edging of the rectangular flowfield in FIG. 2a. By way of this, the membrane 8 which is arranged between the first flat side 3a as well as a surface which borders this, for example a further flat side of an adjacent supply plate 2, may also be pressed in its edge region around the active surface (thus around the flowfield). The membrane 8 which borders the flat side 3a hereby is designed such that it is shaped flush at the edge with the outer contour of the supply plate 2. Hereby, the membrane 8 comprises recesses in the region of the interface channel 5a, and specifically also in the region of the rear side of the second section 7b. Thus it is ensured by way of this that the membrane 8 with its complete surface is always pressed onto an adjacent flat side or plate. On account of this, it is not possible for reaction fluid which is led through the interface channel 5b to flow onto the “rear side” of the membrane. Due to the pressing according to the invention, it is therefore impossible for an operating medium such as molecular hydrogen, methanol or also oxygen to simultaneously contact both sides of the membrane from a single interface channel, on both sides of the membrane. By way of this, a mixing of the reaction media is avoided, and the efficiency of the electrochemical system present here (here a PEMFC) is maintained.

A further membrane (likewise not represented in FIGS. 2a and 2b) is arranged on the rear side of the supply plate, thus on the second flat side 3b of the supply plate 2 shown in FIG. 2b, wherein this membrane also completely spans the flowfield there, and is cut out in regions, amongst others in the region of interface channels 5a and 5b. Here however, the region allocated to the second section 7b is covered with a membrane, and the rear side of the first section 7a connecting thereto is likewise covered with a membrane which is adequately fixed by way of the contact on both sides with the flat sides of the adjacent supply plate in the region of the section 7b. Furthermore, the medium flowing there prevents the membrane from falling into the transition region 7a. The region of the rear side of the transition region 7a is spanned by the membrane 8 in order to ensure the separation of both reaction media.

The present bipolar plate is thus provided with a reaction membrane on both sides, this however is only to be understood as an example. Instead of a polymerelectrolyte membrane attached-on both sides, for example also simple separators etc. may be attached with other systems. It is also to be mentioned that on account of the different “cut-out” of the membranes on the first or the second flat side of the supply plate, one may prevent a inversion of these membranes. It is also to be mentioned that the arrangement of the membranes which is flush at the outer edge is not compelling. Instead of this, these may also be set back with respect to the edge contour in the plane of the plate, and here, as the case may be, one should provide a compensation by way of a plate projection. As is shown in FIGS. 2a and 2b, here the first and the second section are arranged offset to one another in the plane of the plate, i.e. that a reaction medium in each case on the sides distant to the pressing sides of the first and second section may get from the interface channel to the flowfield by way of an “alternating tunnel”. With thus, in the plate edging which otherwise remains equal with regard to thickness, the sections (the first and also the second section) are only 50% as thick as the edge which surrounds towards the outer contour of the supply plate, so that an adequate flow of the medium is ensured.

The present application is explained by way of a PEMFC. Similar systems according to the invention are also to be designed as a DMFC, high temperature fuel cells, electrochemical hydrogen compressors or electrolysers. The supply plate may for example be designed as a metal part, as a metal-coated plastic or as a graphite composite plate. Alternatively these base bodies may be peripherally injected with plastic at least in regions (edge molded).

Here the supply plate is designed as a metal basic part which has been peripherally injected with plastic. This supply plate may however alternatively be represented as a graphite composite plate.

A second embodiment of the present invention is now explained by way of the FIGS. 3a to 3c.

It is to be emphasised that all of the above explanations in their entirety also apply to these embodiments shown in the FIGS. 3a to 3c, unless is expressly stated otherwise. In cases of doubt however, that which has been said above is the case. The elements corresponding to FIGS. 2a and 2b are characterised in FIGS. 3a to 3c with an additional streak in order to simplify the differentiation here.

The main difference between the embodiment shown in FIGS. 2a and 2b on the one hand and that shown in FIGS. 3a to 3c on the other hand is the fact that with FIGS. 2a and 2b, it is the case of a bipolar plate, and with FIGS. 3a to 3c it is the case of a monopolar current collector plate.

The bipolar plate has a first flat side and a first flowfield, and a second flat side and a second flowfield, wherein the first flowfield is connected to an allocated first interface channel and the second flowfield to an allocated second interface channel, in a fluid-leading manner, and no connection is given between the flowfields.

In contrast, the monopolar current collector plate likewise on a first flat side has a first flowfield, and at a second flat side a second flowfield, wherein however both flowfields are connected to a common interface channel.

FIGS. 3a and 3b show a supply plate which is designed as a monopolar current collector plate 2′, which comprises an interface channel 5a′, from which medium via second sections 7b′ as well as a first section 7a′ may get to a flowfield 4a′ which as a continuous (open at both sides) meander supplies the membranes which in each case border the flat sides 3a′/3b′ of the supply plate 2′ with medium. The membrane 8 which thereby borders the flat side 3a′ is likewise cut out in the region of the interface channel 5a′, and completely spans the surface of the flowfield 4a′.

On account of the first section 7a′, it is ensured that no “unsupported” sections of the membrane 8 are given also in the edge region of the flowfield and that this membrane is thus pressed over its whole surface onto the plate sections bordering the flat side 3a′. The same also applies to the flat side 3b′ lying on the other side, or the corresponding flowfield 4b′.

The transition region 6′ here again consists of a first section 7a′ (which borders the flowfield) as well as a second section 7b′ which connects on the oppositely lying flat side in the region of the interface channel. Here too, the transition region which consists of a first and a second section is designed as an “alternating tunnel”. With this however, a significantly larger width of the second section of the transition region 6′ is to be ascertained (this extends over the whole long side of the interface channel, as is to be seen in FIG. 3a), so that here, additional “support structures” 9 are provided. These “support structures” are designed as two “support postlets”, so that a support structure results in the region between the first section 7a′ and the second section 7b′ towards the respective flat sides of the bordering support structure.

This may also be taken into account with membranes which are laid on. The support structure 9′ on the first and/or second flat side 3a′ and 3b′ respectively may be raised beyond the respective flat side, distally to the oppositely lying flat side, over the remaining plane of the plate. By way of this, the membrane which is missing in this region is compensated, i.e. the hight of the postlets is sufficient in order to replace the membrane with regard to thickness in the direction of the layering 12.

A PEMFC stack which is constructed out of the supply plate shown in the FIGS. 3a and 3b is shown in FIG. 3c in a part step.

Here, in the interface channel on the left side, it may be easily recognised how the support structures 9′ project upwards beyond the second to top plate, in order thus to replace the section of the membrane 8 which is not provided in this region.

1. An electrochemical system with at least one supply plate, wherein
the supply plate on a first flat side comprises a first flowfield, and on a second flat side a second flowfield and
the first flowfield is connected to an allocated first interface channel, and the second flowfield is connected to an allocated second interface channel, in a fluid-leading manner, or an individual interface channel is connected to the first and to the second flowfield in a fluid-leading manner, wherein
a transition region is arranged from at least one interface channel to the allocated flowfield or to the allocated flowfields, wherein this transition region on the first flat side comprises a first section, and on the second flat side comprises a second section, for pressing a membrane bordering the respective flat side, wherein the first and second section are offset in the plane of the plate, so that a reaction media flowing in each case on the sides which are distant to the pressing sides of the first and second channel may get from the interface channel to the flowfield or the flowfields.

2-18. (canceled)
